(19) United States
(12) Patent Application Publication
(10) Pub. No.: US 2026/0037772 A1
(43) Pub. Date: Feb. 5, 2026

(54) HYBRID NEURAL NETWORK SYSTEM FOR PROCESSING GRAPH-STRUCTURED AND SEQUENTIAL DATA

(71) Applicant: RAPTORXAI PRIVATE LIMITED, Tellapur (IN)

(72) Inventor: Pratyusha Vemuri Venkata, Tellapur (IN)

(21) Appl. No.: 19/288,793

(22) Filed: Aug. 1, 2025

(30) Foreign Application Priority Data
Aug. 4, 2024 (IN) 202441058869

(51) Int. Cl. G06N 3/042; G06N 3/0442; G06N 3/0464; G06N 3/048

(52) U.S. Cl. CPC G06N 3/042; G06N 3/0442; G06N 3/0464; G06N 3/048

(57) ABSTRACT

A hybrid neural network system for processing graph-structured and sequential data is disclosed. The system comprises a Graph Convolutional Network (GCN) module with multiple graph convolution layers and ReLU activation for processing graph-structured data. It also includes a Recurrent Neural Network (RNN) module with at least one RNN layer and a fully connected layer for processing sequential data. A weighted system combines outputs from the GCN and RNN modules, featuring a learnable parameter “a” to dynamically adjust their contributions. An input component incorporates pre-trained language model (LLM) embeddings or outputs alongside the GCN and RNN outputs. The system generates a combined representation from the GCN module, the RNN module, and the LLM input component to produce a final output.

### FIELD OF THE INVENTION

The invention pertains to the field of neural networks and machine learning. Specifically, the invention relates to hybrid neural network systems and methods designed to process graph-structured and sequential data by integrating Graph Convolutional Networks (GCNs) and Recurrent Neural Networks (RNNs) to enhance feature extraction, representation, and processing capabilities for improved performance in various applications.

### BACKGROUND OF THE INVENTION

The field of neural networks and machine learning has seen significant advancements in recent years, particularly in the development and application of Graph Convolutional Networks (GCNs) and Recurrent Neural Networks (RNNs). Despite these advancements, several critical issues remain unresolved in the existing technologies, limiting their effectiveness in processing complex and diverse data types.

One of the primary problems in the prior art is the limited integration of different neural network architectures. Traditional systems typically rely on a single type of neural network, which restricts their ability to process various data types and capture intricate relationships. For instance, GCNs are proficient in handling graph-structured data but fall short when it comes to processing sequential information. Conversely, RNNs excel in dealing with sequential data but struggle with the complexities of graph-structured data. This lack of integration results in models that are not robust enough to handle the diverse data encountered in real-world applications.

Prior art also suffers from insufficient parameter sharing between different components of the neural network. In many existing systems, the components operate in isolation, without sharing learned features. This isolation leads to redundancy and decreased efficiency, as the model cannot leverage common patterns learned from different data types. Effective parameter sharing is essential for improving the model's performance and reducing computational overhead.

Balancing the contributions of different model components is another challenge in existing technologies. Current approaches often lack effective mechanisms to dynamically adjust the importance of various inputs or sub-networks. This rigidity can lead to suboptimal performance, particularly when dealing with diverse data where the relevance of different components may vary. A flexible system that can adaptively balance these contributions is crucial for achieving robust and accurate predictions.

Moreover, existing systems are often limited in their ability to incorporate domain-specific knowledge. Many models lack straightforward methods to inject task-specific parameters or prior knowledge into the learning process. This limitation hinders the model's ability to be fine-tuned for specific applications, reducing its overall effectiveness. Incorporating domain expertise is vital for improving the model's performance in specialized tasks.

Handling temporal dependencies in data is another area where prior art falls short. Many graph-based models struggle to incorporate temporal information, which is critical for tasks involving time-varying graph structures or node features that change over time. RNNs can address this issue, but integrating them effectively with GCNs to capture both spatial and temporal dependencies remains a challenge. Without this integration, models cannot fully exploit the rich information present in time-series data.

Additionally, existing technologies often face difficulties in processing variable-length input sequences. RNNs are naturally suited for handling inputs of varying lengths, but many fixed-architecture networks cannot accommodate this variability. This limitation restricts the application of these models to scenarios where input lengths are consistent, thereby reducing their versatility.

Current systems lack the capability to effectively balance the extraction of local and global temporal patterns. While RNNs can identify local sequential patterns, a fully connected layer can help recognize global temporal structures. Combining these capabilities in a cohesive manner is essential for robust feature extraction from sequential data, complementing the hierarchical spatial feature learning done by GCNs.

The existing technologies in the field of neural networks and machine learning face several critical issues, including limited integration of neural network architectures, inflexibility in handling diverse data types, insufficient parameter sharing, and difficulties in incorporating domain-specific knowledge. Additionally, challenges in balancing model components, handling temporal dependencies, processing variable-length sequences, and extracting both local and global patterns further limit the effectiveness of current models.

### SUMMARY OF THE INVENTION

To address the foregoing problems, in whole or in part, and/or other problems that may have been observed by persons skilled in the art, the present disclosure provides compositions and methods as described by way of example as set forth below.

The principal object of the present invention is to develop a hybrid neural network system that integrates Graph Convolutional Networks (GCNs) and Recurrent Neural Networks (RNNs) for processing both graph-structured and sequential data, thereby enhancing the overall feature extraction, representation, and processing capabilities.

Another object of the invention is to create a weighted system with a learnable parameter “a” that dynamically adjusts the contribution of the GCN and RNN modules, optimizing the balance between graph-structured and sequential data processing.

Another object of the invention is to incorporate pre-trained language model (LLM) embeddings or outputs into the input component, allowing the system to leverage additional contextual information and improve the combined representation from GCN and RNN modules.

Another object of the invention is to enable effective parameter sharing and integration between the GCN and RNN components, reducing redundancy and computational overhead while improving the efficiency and performance of the hybrid neural network system.

Another object of the invention is to ensure the system can be fine-tuned for specific tasks by incorporating domain-specific knowledge and task-specific loss functions, thereby enhancing its applicability and effectiveness in specialized applications.

In view of the foregoing, the present invention provides a hybrid neural network system for processing graph-structured and sequential data comprises a Graph Convolutional Network (GCN) module configured to process graph-structured data, wherein the GCN module includes multiple graph convolution layers and ReLU activation. It also includes a Recurrent Neural Network (RNN) module configured to process sequential data, wherein the RNN module includes at least one RNN layer and a fully connected layer. Additionally, there is a weighted system configured to combine outputs from the GCN module and the RNN module, wherein the weighted system includes a learnable parameter “a” for dynamically adjusting the contribution of the GCN and RNN modules. The system also features an input component configured to incorporate pre-trained language model (LLM) embeddings or outputs alongside the GCN and RNN outputs. Consequently, the hybrid neural network system is configured to generate a combined representation from the GCN module, the RNN module, and the LLM input component for producing a final output.

In another aspect of the present invention, the GCN module comprise a first graph convolution layer configured to perform initial feature transformation on graph-structured data, a ReLU activation layer configured to introduce non-linearity and a second graph convolution layer configured to capture higher-order graph structure information.

In another aspect of the present invention, the RNN module comprises an RNN layer selected from the group consisting of Long Short-Term Memory (LSTM) and Gated Recurrent Unit (GRU) architectures.

In another aspect of the present invention, the fully connected layer in the RNN module is configured to transform RNN outputs into a fixed-dimensional representation.

In another aspect of the present invention, the weighted system utilizes an attention mechanism to dynamically adjust the contribution of the GCN and RNN modules based on the input characteristics.

In an another embodiment, the invention provides a method for processing graph and sequential data. The method comprises a) inputting graph-structured data into a Graph Convolutional Network (GCN) component b) inputting sequential data into a Recurrent Neural Network (RNN) component c) extracting features from the graph-structured data using the GCN component, wherein the GCN component comprises at least one graph convolutional layer followed by a non-linear activation function d) extracting features from the sequential data using the RNN component, wherein the RNN component comprises at least one RNN layer and a fully connected layer e) combining the extracted features from the GCN component and the RNN component using a weighted system f) adjusting the contribution of the extracted features from the GCN component and the RNN component using a learnable parameter g) generating a final output based on the combined features from the GCN component and the RNN component.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 illustrates a system design of graph Recurrent Neural Network (RNN), in accordance with an embodiment of the present invention;

FIG. 2A illustrates a Node distribution visualisation of original GCN model, in accordance with an embodiment of the present invention;

FIG. 2B illustrates a Node distribution visualization of GraphRNN model, in accordance with an embodiment of the present invention;

Skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The present invention discloses a hybrid neural network system designed to process both graph-structured and sequential data, leveraging the strengths of Graph Convolutional Networks (GCNs) and Recurrent Neural Networks (RNNs). The system comprises a GCN module that processes graph-structured data through multiple graph convolution layers and ReLU activation functions. This module is capable of extracting intricate features from graph data, making it suitable for applications where relationships between entities are best represented as graphs.

Complementing the GCN module, the system includes an RNN module configured to handle sequential data. This module comprises at least one RNN layer, which can be either a Long Short-Term Memory (LSTM) or Gated Recurrent Unit (GRU), followed by a fully connected layer. The RNN module excels in capturing temporal dependencies and sequential patterns, making it ideal for tasks involving time-series data or sequences.

The invention is the weighted system that combines the outputs of the GCN and RNN modules. This system incorporates a learnable parameter “a” that dynamically adjusts the contributions of the GCN and RNN outputs, optimizing the balance based on the specific data being processed.

Additionally, the system features an input component designed to integrate pre-trained language model (LLM) embeddings or outputs alongside the GCN and RNN outputs, thereby enriching the final representation with contextual information from the LLM.

The hybrid neural network system ultimately generates a combined representation from the GCN module, the RNN module, and the LLM input component. This combined representation is used to produce the final output, enhancing the system's capability to handle complex and diverse data types. By integrating these different neural network architectures and dynamically balancing their contributions, the invention provides a robust and versatile solution for various applications, including social network analysis, financial fraud detection, and other tasks requiring the processing of graph-structured and sequential data.

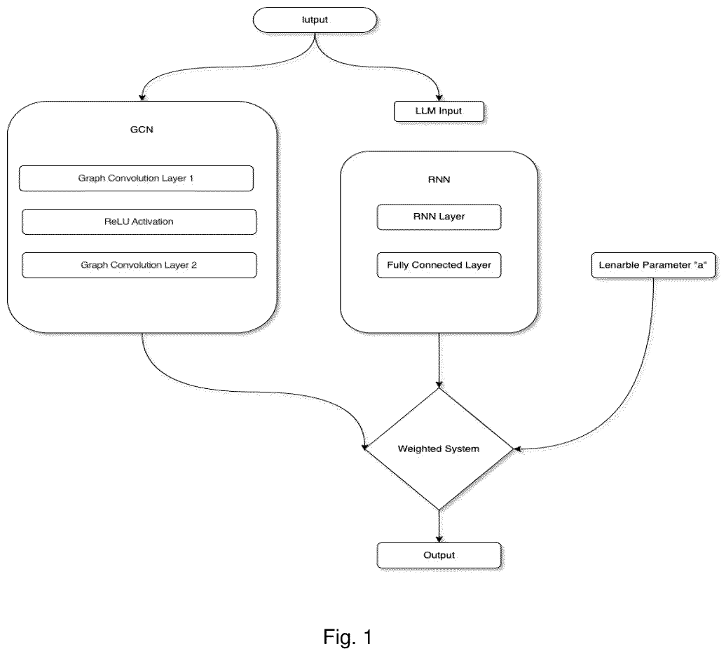

In accordance with an embodiment of the present invention, this FIG. 1 illustrates the architecture of a hybrid neural network system designed to process both graph-structured and sequential data. The system starts with an input phase where data, including graph-structured data, sequential data, and optionally pre-trained language model (LLM) embeddings or outputs, is fed into the system. The first major component, the Graph Convolutional Network (GCN) module, consists of a Graph Convolution Layer 1, which performs localized feature learning on the graph-structured data by taking node features and an adjacency matrix as inputs and outputting updated node representations. This is followed by a ReLU activation function, which introduces non-linearity to capture complex patterns. The GCN module also includes a Graph Convolution Layer 2 that conducts higher-order neighborhood aggregation, resulting in final graph-level or node-level embeddings.

In parallel, the Recurrent Neural Network (RNN) module processes sequential or time-series data through an RNN layer, which may use Long Short-Term Memory (LSTM) or Gated Recurrent Unit (GRU) architectures for enhanced long-term dependency modeling. The outputs from the RNN layer are then transformed into a fixed-dimensional representation by a fully connected layer. Additionally, the system features an LLM input component that integrates pre-trained language model embeddings or outputs, enriching the feature set with contextual information. A key feature of the invention in the disclosed system is the learnable parameter “a”, a scalar or vector parameter that can be optimized during training, allowing for dynamic adjustment of the contributions from the GCN and RNN modules. These outputs, along with the LLM inputs, are combined using a weighted system that employs a learnable weighting mechanism. This system may utilize attention mechanisms or gating networks to dynamically adjust the contributions of each component.

Finally, the integrated representation from the weighted system is used to produce the final output, which depends on the specific task, such as classification, regression, or sequence generation. This figure visually represents the workflow and interaction between the different modules, highlighting how data flows through the system and is processed to generate the final output.

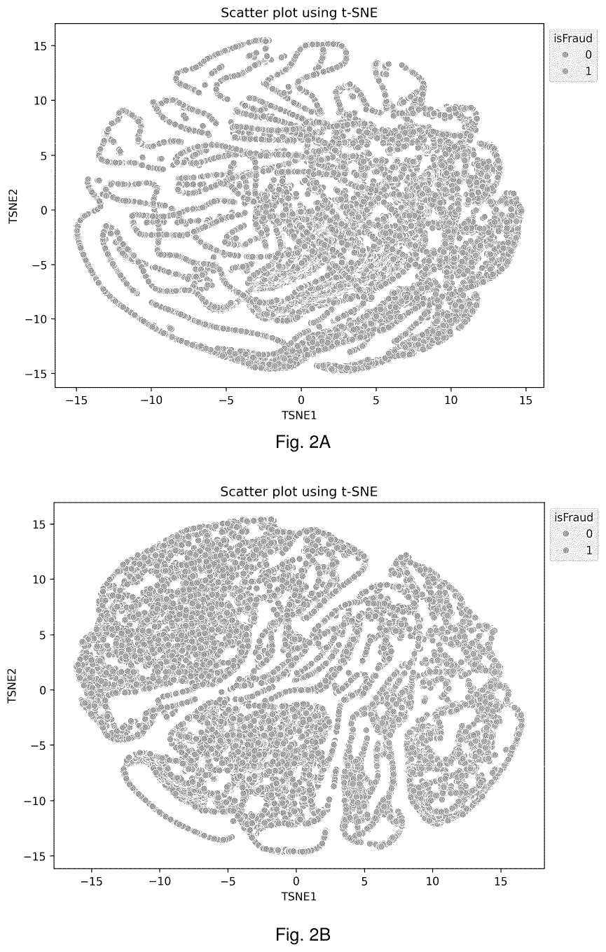

In accordance with an embodiment of the present invention, FIG. 2A illustrates a Node distribution visualisation of original GCN model and FIG. 2B illustrates a Node distribution visualization of GraphRNN model. These figures show the scatter plots generated using t-SNE (t-Distributed Stochastic Neighbor Embedding), a technique for dimensionality reduction that helps visualize the high-dimensional data patterns and relationships within the graph-structured data processed by each model.

In an embodiment, the invention pertains to a hybrid neural network system designed to process graph-structured and sequential data effectively by integrating Graph Convolutional Networks (GCNs) and Recurrent Neural Networks (RNNs). This system leverages the strengths of both types of networks to handle different data forms. The GCN module features a first graph convolution layer that performs localized feature learning on graph-structured data, taking node features and an adjacency matrix as input and outputting updated node representations. Following this, a ReLU activation function introduces non-linearity to enhance the model's ability to capture complex patterns. A second graph convolution layer then performs higher-order neighborhood aggregation, resulting in final graph-level or node-level embeddings that provide a comprehensive representation of the graph data.

In an embodiment, in parallel, the RNN module processes sequential or time-series data through an RNN layer, which can utilize Long Short-Term Memory (LSTM) or Gated Recurrent Unit (GRU) architectures for improved long-term dependency modeling. The outputs from the RNN layer are transformed into a fixed-dimensional representation by a fully connected layer. Additionally, the system features an input component for integrating pre-trained language model (LLM) embeddings or outputs, enriching the feature set with contextual information derived from language models.

Further, an important feature of the innovation is the learnable parameter “a”, a scalar or vector parameter optimized during training that allows for task-specific fine-tuning and the incorporation of domain knowledge. This parameter plays a crucial role in the weighted system, which combines outputs from the GCN, RNN, and LLM components. The weighted system may use attention mechanisms or gating networks to dynamically adjust the contributions of each component, ensuring optimal feature integration.

In an embodiment, the workflow of the system begins with input processing, where graph data is fed into the GCN module and sequential data into the RNN module. The GCN module performs initial feature transformation through the first convolution layer, applies ReLU activation for non-linearity, and captures higher-order graph structure information through the second convolution layer. Simultaneously, the RNN module processes sequential inputs, maintaining internal state, and transforms the RNN outputs into a fixed representation. If applicable, the LLM input generates additional features from the language model.

The outputs from the GCN, RNN, and LLM components are then fed into the weighted system, where the learnable parameter “a” modulates their contributions. The weighted system computes a combined representation, possibly using techniques such as weighted sum, gating mechanisms, or multi-head attention, and this integrated representation is used to produce the final output tailored to specific tasks like classification, regression, or sequence generation. The system is trained end-to-end using backpropagation, with task-specific loss functions for each module, optimizing the learnable parameter “a” alongside network weights. Techniques such as gradient clipping, layer normalization, or residual connections may be employed to stabilize training and enhance performance.

During deployment, the trained model processes new inputs through this established workflow, with the weighted system dynamically adjusting the contribution of each component based on input characteristics and learned parameters. This robust and versatile solution is applicable to various domains, including social network analysis and financial fraud detection, by efficiently processing complex and diverse data types through the integrated GCN and RNN architectures.

### Example: Transaction Dataset

### IBM Transactions for Anti Money Laundering (AML)

### Kaggle: IBM Transactions for Anti Money Laundering (AML)

### Data Description:

The disclosed invention adjusts the data to have the same number of “fraud” and “not fraud” examples.

TABLE 1
Data Statistics Distribution

| | Train | Validation | Test |
|---|---|---|---|
| | dataset | dataset | dataset |
| Number of data | 9464 | 4685 | 9513 |
| Number of features | 38 | 38 | 38 |

TABLE 2
Evaluation results for different models

| Model | Accuracy | F1 Macro Score | ROC-AUC Score |
|---|---|---|---|
| GNN | 67.77% | 60.99% | 63.43% |
| GraphRNN | 98.97% | 98.69% | 98.82% |

### Some of the Non-Limiting Advantages of the Present Invention are

Improved performance in graph-based tasks by combining Graph Convolutional Networks (GCN) with Recurrent Neural Networks (RNN).
Enhanced ability to capture both spatial and temporal dependencies in data through the integration of GCN and RNN architectures.
Increased flexibility and adaptability of the system through the incorporation of a learnable parameter “a” in the weighted system.
Potential for better generalization to unseen graph structures due to the GCN component.
Capability to process sequential data effectively using the RNN component.
Optimized balance between graph-based and sequence-based feature extraction, leading to more robust and accurate predictions.

Terms and phrases used in this document, and variations thereof, unless otherwise expressly stated, should be construed as open-ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art. Although the foregoing subject matter has been described in some detail by way of illustration and example for purposes of clarity of understanding, it will be understood by those skilled in the art that certain changes and modifications can be practiced within the scope of the appended claims.

What is claimed is:

1. A hybrid neural network system for processing graph-structured and sequential data, comprising:
a Graph Convolutional Network (GCN) module configured to process graph-structured data, wherein the GCN module includes multiple graph convolution layers and ReLU activation;
a Recurrent Neural Network (RNN) module configured to process sequential data, wherein the RNN module includes at least one RNN layer and a fully connected layer;
a weighted system configured to combine outputs from the GCN module and the RNN module, wherein the weighted system includes a learnable parameter “a” for dynamically adjusting the contribution of the GCN and RNN modules;
an input component configured to incorporate pre-trained language model (LLM) embeddings or outputs alongside the GCN and RNN outputs;
wherein the hybrid neural network system is configured to generate a combined representation from the GCN module, the RNN module, and the LLM input component for producing a final output.

2. The hybrid neural network system of claim 1, wherein the GCN module comprises:
a first graph convolution layer configured to perform initial feature transformation on graph-structured data;
a ReLU activation layer configured to introduce non-linearity;
a second graph convolution layer configured to capture higher-order graph structure information.

3. The hybrid neural network system of claim 1, wherein the RNN module comprises:
an RNN layer selected from the group consisting of Long Short-Term Memory (LSTM) and Gated Recurrent Unit (GRU) architectures.

4. The hybrid neural network system of claim 1, wherein:
the fully connected layer in the RNN module is configured to transform RNN outputs into a fixed-dimensional representation.

5. The hybrid neural network system of claim 1, wherein:
the weighted system utilizes an attention mechanism to dynamically adjust the contribution of the GCN and RNN modules based on the input characteristics.

6. The hybrid neural network system of claim 1, wherein the learnable parameter “a” is a scalar parameter that can be optimized during training to incorporate domain-specific knowledge.

7. The hybrid neural network system of claim 1, wherein the weighted system employs a gating mechanism to selectively combine the outputs from the GCN, RNN, and LLM components.

8. The hybrid neural network system of claim 1, wherein the system is configured for transfer learning by allowing the shared representations from the GCN and RNN modules to be fine-tuned for specific tasks.

9. The hybrid neural network system of claim 1, wherein:
the system includes a mechanism for gradient clipping to stabilize training and prevent exploding gradients.

10. The hybrid neural network system of claim 1, wherein the system is configured to handle variable-length input sequences through the RNN module.

11. The hybrid neural network system of claim 1, wherein the system includes a mechanism for layer normalization to improve training stability and convergence speed.

12. The hybrid neural network system of claim 1, wherein the final output is generated using a task-specific loss function optimized for classification, regression, or sequence generation tasks.

13. A method for processing graph and sequential data, the method comprising:
a) inputting graph-structured data into a Graph Convolutional Network (GCN) component;
b) inputting sequential data into a Recurrent Neural Network (RNN) component;
c) extracting features from the graph-structured data using the GCN component, wherein the GCN component comprises at least one graph convolutional layer followed by a non-linear activation function;
d) extracting features from the sequential data using the RNN component, wherein the RNN component comprises at least one RNN layer and a fully connected layer;
e) combining the extracted features from the GCN component and the RNN component using a weighted system;
f) adjusting the contribution of the extracted features from the GCN component and the RNN component using a learnable parameter;
g) generating a final output based on the combined features from the GCN component and the RNN component.
